(19) United States
(12) Patent Application Publication
(10) Pub. No.: US 2018/0052749 A1
(43) Pub. Date: Feb. 22, 2018

(54) INFORMATION PROCESSING SYSTEM AND INFORMATION PROCESSING METHOD

(71) Applicant: FUJITSU LIMITED, Kawasaki-shi (JP)

(72) Inventor: Akihiro Sugaya, Kawasaki (JP)

(73) Assignee: FUJITSU LIMITED, Kawasaki-shi (JP)

(21) Appl. No.: 15/666,004

(22) Filed: Aug. 1, 2017

(30) Foreign Application Priority Data
Aug. 18, 2016 (JP) 2016-160288

(51) Int. Cl. G06F 11/20; G06F 3/06

(52) U.S. Cl. CPC G06F 11/2064; G06F 3/0646; G06F 11/2069; G06F 11/2087

(57) ABSTRACT

An information processing device includes a processor configured to perform data copy from a first storage device to a second storage device. The processor receives a write request while performing the data copy. The write request requests to write first data in a first area of the first storage device. The processor performs first data write of writing the first data in the first area. The processor performs second data write of writing the first data in a second area of the second storage device. The second area corresponds to the first area. The processor stores abnormality information in the memory upon detecting normal completion of the second data write and an error occurred in the first data write. The abnormality information indicates the first area. The processor continuously performs the data copy while excluding data stored in the first area from copy-target data on basis of the abnormality information.

### CROSS-REFERENCE TO RELATED APPLICATION

This application is based upon and claims the benefit of priority of the prior Japanese Patent Application No. 2016-160288, filed on Aug. 18, 2016, the entire contents of which are incorporated herein by reference.

### FIELD

The embodiments discussed herein are related to an information processing system and an information processing method.

### BACKGROUND

A storage device that performs mirroring control copies data from one disk (copy source disk) to another disk (copy destination disk). If an error occurs on the copy source disk during a copy process, the copy process is generally aborted. In this case, since the copy process is not completed and the contents in the copy destination disk are not guaranteed, the copy destination disk is separated from the mirroring, and as a result, the copy source disk becomes an operation disk. However, since the error occurs during the copy process in the copy source disk, the copy source disk does not have a sufficient qualification as an operation disk.

Therefore, there has been a storage device in which, when an error occurs in the copy source disk during the copy process, the copy source disk is separated from the mirroring and the copy destination disk is used as an operation disk.

Related techniques are disclosed in, for example, Japanese Laid-Open Patent Publication No. 2010-186285.

### SUMMARY

According to an aspect of the present invention, provided is an information processing device including a memory and a processor coupled to the memory. The processor is configured to perform data copy of copying data from a first storage device to a second storage device. The processor is configured to receive a first write request while performing the data copy. The first write request requests to write first data in a first area of the first storage device. The processor is configured to perform first data write of writing the first data in the first area. The processor is configured to perform second data write of writing the first data in a second area of the second storage device. The second area corresponds to the first area. The processor is configured to store abnormality information in the memory upon detecting normal completion of the second data write and an error occurred in the first data write. The abnormality information indicates the first area. The processor is configured to continuously perform the data copy while excluding data stored in the first area from copy-target data on basis of the abnormality information stored in the memory. The copy-target data is data to be copied by the data copy.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing system according to a first embodiment;

FIG. 2 is a diagram illustrating an example of a storage device according to a second embodiment;

FIG. 3 is a diagram illustrating an exemplary hardware configuration of a CM according to the second embodiment;

FIG. 4 is a diagram illustrating an exemplary functional configuration of the CM according to the second embodiment;

FIG. 5A is a diagram illustrating a format of a mirror disk management table according to the second embodiment;

FIG. 5B is a diagram illustrating a specific example of the mirror disk management table according to the second embodiment;

FIGS. 6A and 6B are diagrams illustrating examples of a disk state according to the second embodiment;

FIG. 7 is a diagram illustrating examples of a write area management table and the like according to the second embodiment;

FIG. 8 is a flowchart illustrating an example of a normal write process according to the second embodiment;

FIG. 9 is a flowchart illustrating an example of a normal read process according to the second embodiment;

FIG. 10 is a flowchart illustrating an example of a copy process according to the second embodiment;

FIG. 11 is a flowchart illustrating an example of the copy process according to the second embodiment;

FIG. 12 is a flowchart illustrating an example of a write-in-copy process according to the second embodiment;

FIG. 13 is a flowchart illustrating an example of a read-in-copy process according to the second embodiment;

FIG. 14 is a flowchart illustrating an example of the read-in-copy process according to the second embodiment; and

FIGS. 15A to 15C are diagrams illustrating examples of a write-in-copy process according to the second embodiment.

### DESCRIPTION OF EMBODIMENTS

In the storage device in which the copy source disk is separated from the mirroring and the copy destination disk is used as an operation disk, when the error occurs in the copy source disk during the copy process, the copy source disk does not have the qualification as an operation disk and the data may be non-guaranteed even in the copy destination disk.

Hereinafter, embodiments will be described with reference to the accompanying drawings.

### First Embodiment

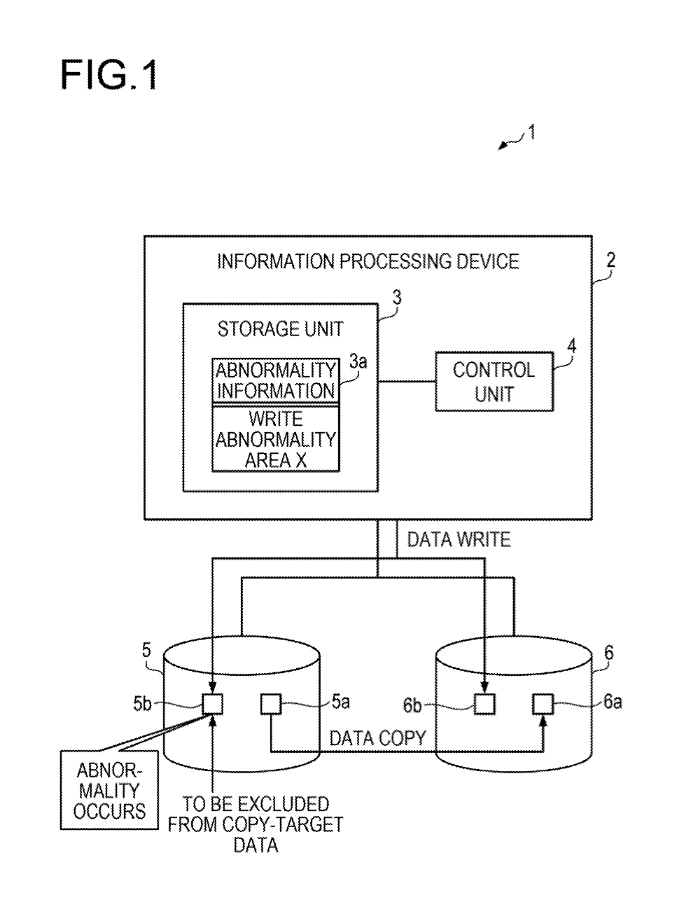

FIG. 1 is a diagram illustrating an example of an information processing system according to a first embodiment. The information processing system 1 includes an information processing device 2, a first storage device 5, and a second storage device 6. For example, the first storage device 5 and the second storage device 6 are hard disk drives (HDDs).

The information processing device 2 includes a storage unit 3 and a control unit 4. For example, the storage unit 3 is a random access memory (RAM) and the like. For example, a processor performs a required process to implement the control unit 4.

The control unit 4 performs data copy of copying data from the first storage device 5 to the second storage device 6. The second storage device 6 is a storage device which becomes a duplication of the first storage device 5. That is, the first storage device 5 is a storage device of a copy source. The second storage device 6 is a storage device of a copy destination. The control unit 4, for example, copies data stored in an area 5a of the first storage device 5 to an area 6a of the second storage device 6.

The control unit 4 may receive a write request while performing the data copy. For example, the control unit 4 receives the write request from a higher-level device. The higher-level device is, for example, a host device. When the control unit 4 receives the write request, the control unit 4 writes data (hereinafter, referred to as “write data”) to be written, which corresponds to the write request, in an area 5b of the first storage device 5 and an area 6b of the second storage device 6.

When the control unit 4 detects normal writing of the write data by the second storage device 6 and abnormal writing of the write data by the first storage device 5 as a result of the write request while performing the data copy, the control unit 4 stores abnormality information 3a in the storage unit 3. The abnormality information 3a is information for identifying a write-abnormality area in the first storage device 5. For example, the abnormality information 3a indicates a write-abnormality area X. The write-abnormality area X is information for identifying the area 5b.

The control unit 4 continuously performs the data copy while excluding the data corresponding to the write-abnormality area from data (hereinafter, referred to as “copy-target data”) to be copied in the data copy on the basis of the abnormality information 3a. For example, the control unit 4 continuously performs the data copy while excluding the data corresponding to the area 5b from the copy-target data in the data copy.

As described above, the information processing device 2 prevents indefinite data from being copied to the second storage device 6 from the first storage device 5 by excluding the data corresponding to the write-abnormality area from the copy-target data in the data copy. As a result, the information processing device 2 prevents a state in which the second storage device 6 which is the storage device of the copy destination does not guarantee data. Since the information processing device 2 normally writes the write data of the write request instead of the data excluded from the copy-target data, the second storage device 6 which is the storage device of the copy destination may be used as a storage device that may guarantee data.

When the first storage device 5 and the second storage device 6 constitute mirroring, the information processing device 2 may exclude the first storage device 5 from the mirroring constituents after completing the data copy of copying data from the first storage device 5 to the second storage device 6.

Accordingly, the information processing system 1 or the information processing device 2 may guarantee data in the storage device of the copy destination even when an error occurs in the storage device of the copy source during a copy process.

### Second Embodiment

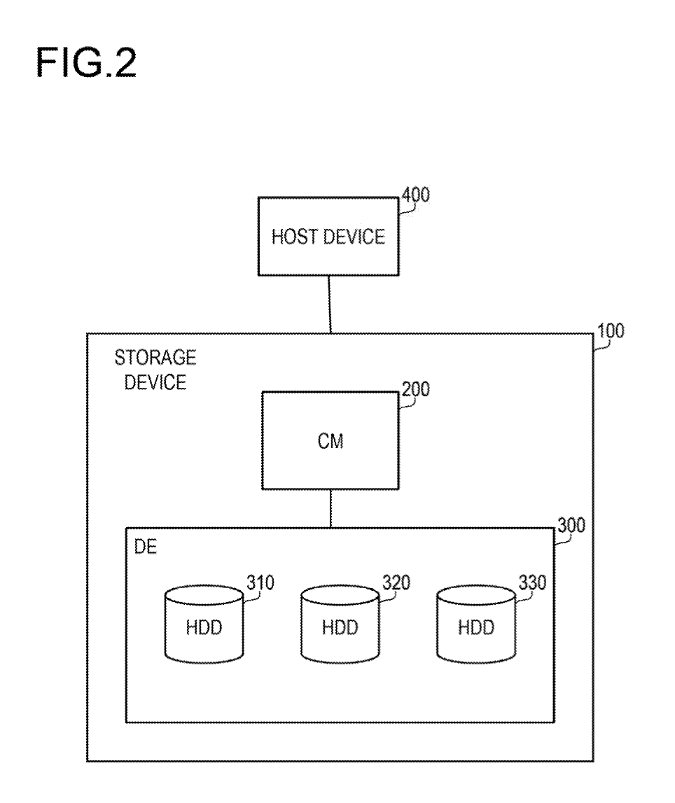

FIG. 2 is a diagram illustrating an example of a storage device according to a second embodiment. A storage device 100 stores therein data handled by a host device 400. The storage device 100 includes a controller module (CM) 200 and a device enclosure (DE) 300. The CM 200 controls an access to the DE 300 from the host device 400.

The DE 300 is a disk array device capable of housing a plurality of storage devices. The DE 300 includes HDDs 310, 320, and 330. The DE 300 may include more than three HDDs. The DE 300 may house solid state drives (SSDs) as the storage devices.

The storage device 100 and the host device 400 are coupled to each other through a network. For example, the storage device 100 and the host device 400 are coupled to each other by a transmission scheme such as a Fibre Channel (FC) or the like.

The CM 200 may manage the HDDs 310 and 320 as a redundant array of inexpensive disks (RAID). The CM 200 designates a logical block address (LBA) of a logical volume set in storage areas of the HDDs 310 and 320 to accesses the HDDs 310 and 320. The CM 200 controls the HDDs 310 and 320 as RAID1. That is, the CM 200 performs mirroring control on the HDDs 310 and 320. The HDDs 310 and 320 serve as mirror disks. The CM 200 stores information used for each process in the HDD 330. Therefore, the HDD 330 serves as a management disk.

It is assumed that the HDD 320 is a newly introduced HDD as a replacement. Therefore, even though the HDD 320 is an HDD among the mirroring constituents, the HDD 320 does not yet store therein data which is duplicated with data stored in the HDD 310. The CM 200 detects addition of the HDD 320 due to a change in the configuration of the storage devices as the mirroring constituents. In the second embodiment, each process is performed while the data stored in the HDDs 310 and 320 do not coincide with each other.

The storage device 100 is an example of the information processing system 1 according to the first embodiment. The CM 200 is an example of the information processing device 2 according to the first embodiment.

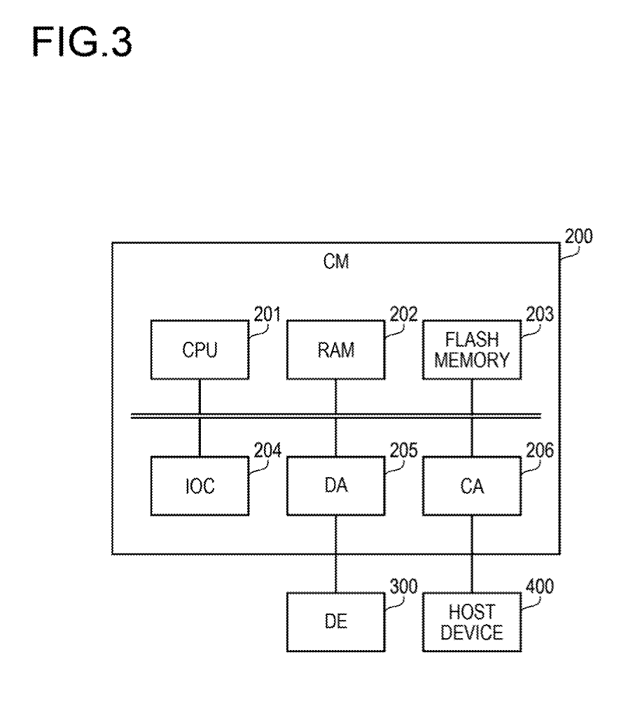

FIG. 3 is a diagram illustrating an exemplary hardware configuration of the CM according to the second embodiment. The CM 200 includes a central processing unit (CPU) 201, a RAM 202, a flash memory 203, an input-output controller (IOC) 204, a disk adapter (DA) 205, and a channel adapter (CA) 206.

The CPU 201 controls information processing of the CM 200. The CPU 201 may be replaced by a digital signal processor (DSP), an application specific integrated circuit (ASIC), a field programmable gate array (FPGA), or the like. The CPU 201 may be a multi-processor.

The RAM 202 is a main storage device of the CM 200. The RAM 202 temporarily stores therein at least a part of a program of an operating system (OS) or an application program executed by the CPU 201. The RAM 202 also stores therein various data used for the information processing performed by the CPU 201.

The flash memory 203 is an auxiliary storage device of the CM 200. The flash memory 203 is a non-volatile storage device. The flash memory 203 stores therein the program of the OS, the application program, and various data. The CM 200 may include, as the auxiliary storage device, an HDD instead of the flash memory 203.

The IOC 204 controls the access to the DE 300 from the host device 400. The DA 205 is an interface for communication with the DE 300. The CA 206 is an interface for communication with the host device 400.

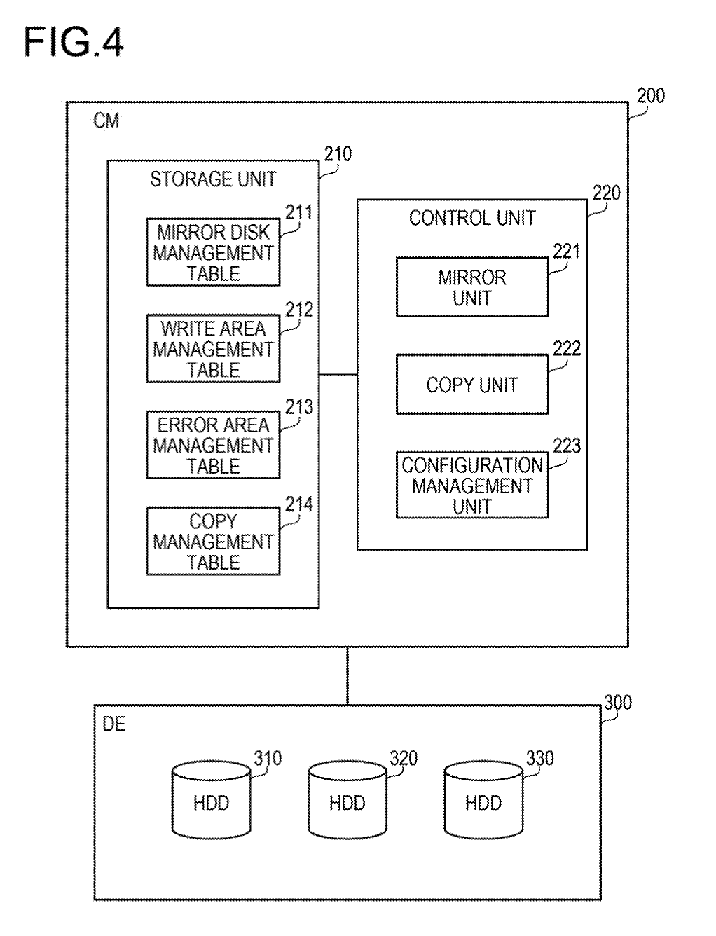

FIG. 4 is a diagram illustrating an exemplary functional configuration of the CM according to the second embodiment. The CM 200 includes a storage unit 210 and a control unit 220.

The storage unit 210 stores therein a mirror disk management table 211, a write area management table 212, an error area management table 213, and a copy management table 214.

The mirror disk management table 211 indicates information on the HDDs as the mirroring constituents. The write area management table 212 indicates areas (hereinafter, referred to as write completion areas) where data has been written. The error area management table 213 indicates areas where an error has occurred. The copy management table 214 indicates areas where data has been copied. The HDD 330 stores therein the mirror disk management table 211 and the write area management table 212 while the storage device 100 is in a power-off state.

The control unit 220 includes a mirror unit 221, a copy unit 222, and a configuration management unit 223. The mirror unit 221 performs mirroring control on the HDDs 310 and 320. In a case where the mirror unit 221 receives a write request from the host device 400 while the copy process to be described below is not performed, the mirror unit 221 performs a normal write process. The normal write process will be described later in detail. In a case where the mirror unit 221 receives a write request from the host device 400 during the copy process, the mirror unit 221 performs a write-in-copy process. The write-in-copy process will be described later in detail.

In a case where the mirror unit 221 receives a read request from the host device 400 while the copy process is not performed, the mirror unit 221 performs a normal read process. The normal read process will be described later in detail. In a case where the mirror unit 221 receives a read request from the host device 400 during the copy process, the mirror unit 221 performs a read-in-copy process. The read-in-copy process will be described later in detail.

The copy unit 222 performs the copy process. When the copy unit 222 performs the copy process, the copy unit 222 copies data stored in a copy source disk to a copy destination disk. The copy source disk and the copy destination disk are set by the configuration management unit 223.

The configuration management unit 223 performs an update process of updating the mirror disk management table. The configuration management unit 223 sets any one of the HDDs 310 and 320 as the copy source disk. The configuration management unit 223 may determine which one of HDDs 310 and 320 is to be set as the copy source disk in accordance with an instruction from the host device 400. The configuration management unit 223 sets an HDD other than the copy source disk as the copy destination disk. The setting of the copy source disk and the copy destination disk will be described later in detail.

After the storage device 100 is powered on, the configuration management unit 223 reads the mirror disk management table 211 and the write area management table 212 from the HDD 330. The configuration management unit 223 stores the read mirror disk management table 211 and the write area management table 212 in the storage unit 210.

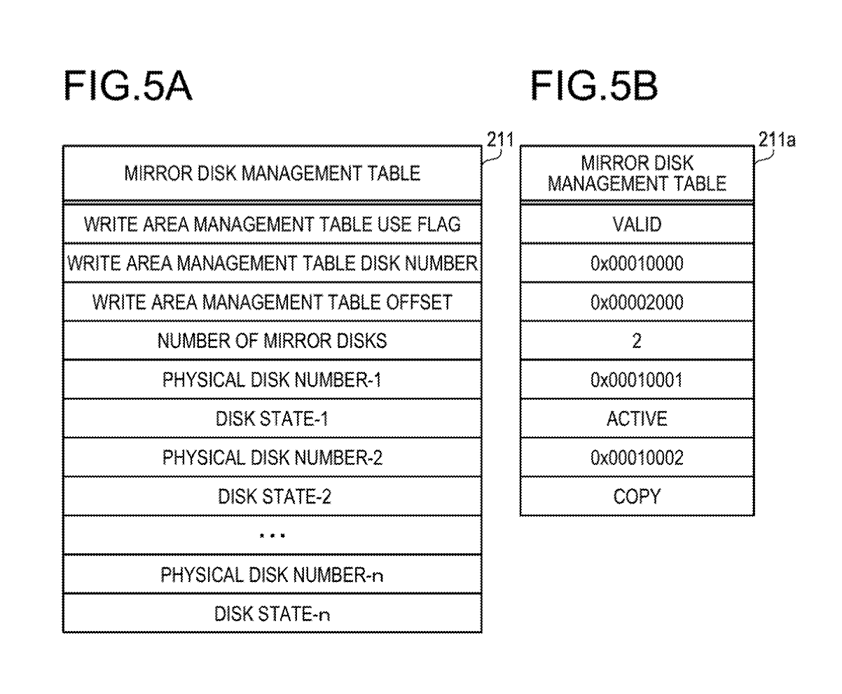

FIGS. 5A and 5B are diagrams illustrating an example of a mirror disk management table according to the second embodiment. FIG. 5A illustrates a format of the mirror disk management table 211. The mirror disk management table 211 includes items of a write area management table use flag, a write area management table disk number, and a write area management table offset. Further, the mirror disk management table 211 includes items of the number of mirror disks, physical disk number-1, disk state-1, physical disk number-2, disk state-2, . . . , physical disk number-n, and disk state-n.

The item of the write area management table use flag indicates whether the write area management table 212 is used. The item of the write area management table use flag indicates any one of “valid” and “invalid”. The “valid” indicates that the write area management table 212 is used. The “invalid” indicates that the write area management table 212 is not used. When the write area management table use flag is “valid”, the copy unit 222 performs data copy for the write completion areas. When the write area management table use flag is “invalid”, the copy unit 222 performs data copy for the entire copy source disk. In the second embodiment, it is assumed that “valid” is set in the item of the write area management table use flag.

The item of the write area management table disk number indicates a device number of a management disk storing the write area management table 212. The item of the write area management table offset indicates a location where the write area management table 212 is stored in the management disk.

The item of the number of mirror disks indicates the number of mirror disks which exist in the DE 300. The item of the physical disk number indicates the device number of a mirror disk. The item of the disk state indicates a state of the mirror disk. The item of the disk state indicates any one of “ACTIVE”, “COPY”, and “INVALID”. The “ACTIVE” indicates that the mirror disk is an operation disk. Further, the “ACTIVE” indicates that the mirror disk is the copy source disk during the copy process. The “COPY” indicates that the mirror disk is the copy destination disk during the copy process. The “INVALID” indicates that the mirror disk is separated from the mirroring configuration. That is, the “INVALID” indicates that the mirror disk is excluded from the mirroring constituents. Further, the “INVALID” indicates that the mirror disk is not an operation disk.

FIG. 5B illustrates a specific example of a mirror disk management table 211a. The mirror disk management table 211a indicates that the write area management table 212 is used (“valid”). The mirror disk management table 211a indicates that the device number of the management disk is “0x00010000”. The mirror disk management table 211a indicates that the write area management table 212 is stored at a location of “0x00002000” in the management disk. The mirror disk management table 211a indicates that the number of mirror disks which exist in the DE 300 is “2”. The mirror disk management table 211a indicates that the device number of the copy source disk (“ACTIVE”) is “0x00010001”. The mirror disk management table 211a indicates that the device number of the copy destination disk (“COPY”) is “0x00010002”.

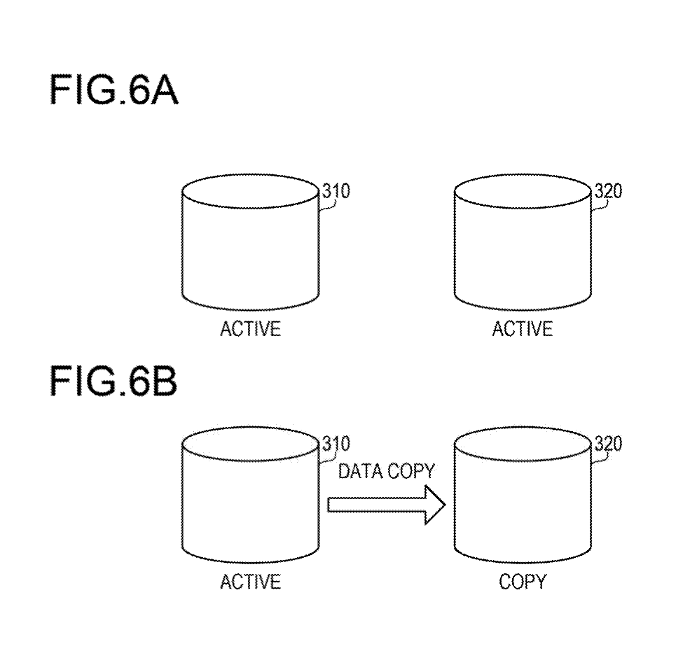

FIGS. 6A and 6B are diagrams illustrating examples of a disk state according to the second embodiment. FIG. 6A illustrates a state before the copy process. FIG. 6A illustrates that the item of the disk state in the mirror disk management table 211 corresponding to the HDDs 310 and 320 is “ACTIVE”.

Before the copy unit 222 performs the copy process, the configuration management unit 223 sets one HDD, among the HDDs having “ACTIVE” in the item of the disk state in the mirror disk management table 211, as the copy source disk. The configuration management unit 223 sets another HDD, among the HDDs having “ACTIVE” in the item of the disk state in the mirror disk management table 211, as the copy destination disk. The configuration management unit 223 registers “COPY” in the item of the disk state in the mirror disk management table 211 corresponding to the HDD set as the copy destination disk. FIG. 6B illustrates that the HDD 310 is set as the copy source disk (the disk state is “ACTIVE”) and the HDD 320 is set as the copy destination disk (the disk state is “COPY”). The HDD 320 is an operation disk even when the HDD 320 is set as the copy destination disk.

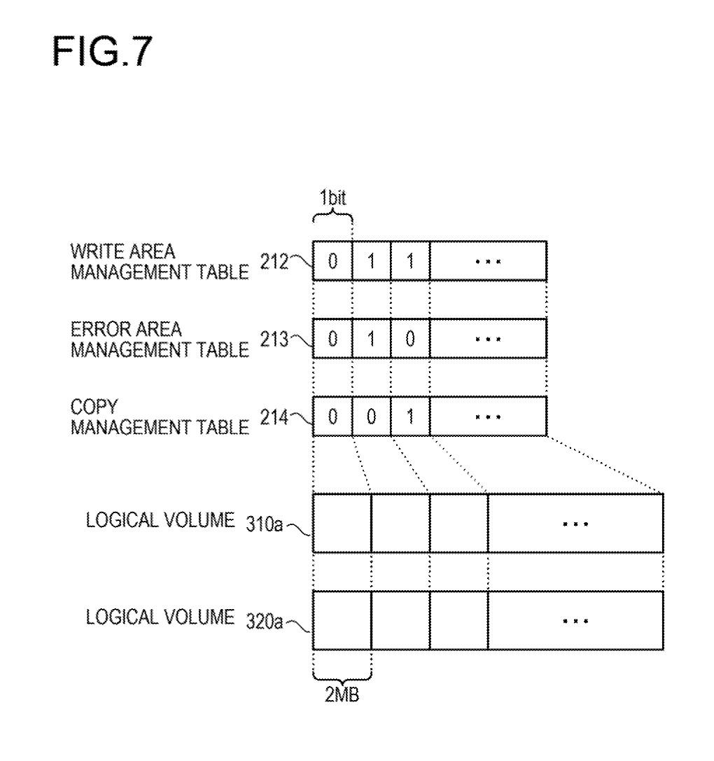

FIG. 7 is a diagram illustrating examples of a write area management table and the like, according to the second embodiment. FIG. 7 illustrates that the write area management table 212, the error area management table 213, and the copy management table 214 have a relationship with a logical volume 310a of the HDD 310 and a logical volume 320a of the HDD 320.

The write area management table 212 indicates, with bits, whether data has been written in an area of the logical volumes 310a and 320a divided into units of 2 MB corresponding to the respective bits. The write area management table 212 may indicate, with bits, whether data has been written in an area of the physical volumes of the HDDs 310 and 320 divided into units of 2 MB corresponding to the respective bits. Each bit of the write area management table 212 indicates any one of “0” and “1”. When the bit is “0”, it indicates that no data has been written in an area corresponding to the bit. When the bit is “1”, it indicates that data has been written in the area corresponding to the bit. When data is written in an area of the logical volume 310a and an area of the logical volume 320a corresponding to the area of the logical volume 310a, the mirror unit 221 sets the bit corresponding to the areas of the logical volumes 310a and 320a as “1”. When data is written in one of an area of the logical volume 310a and an area of the logical volume 320a corresponding to the area the logical volume 310a, the mirror unit 221 sets the bit corresponding to the area where the data is written as “1”.

The error area management table 213 indicates, with bits, whether an error has occurred in an area of the logical volumes 310a and 320a divided into units of 2 MB corresponding to the respective bits. The error area management table 213 may indicate, with bits, whether an error has occurred in an area of physical volumes of the HDDs 310 and 320 divided into units of 2 MB corresponding to the respective bits. Each bit of the error area management table 213 indicates any one of “0” and “1”. When the bit is “0”, it indicates that no error has occurred in an area corresponding to the bit. When the bit is “1”, it indicates that an error has occurred in the area corresponding to the bit. For example, when an error occurs in an area of the logical volume 310a, the mirror unit 221 sets a bit corresponding to the area (hereinafter, referred to as an “error area”) where the error occurs as “1”.

The copy management table 214 indicates, with bits, whether data dopy is completed between areas of the logical volumes 310a and 320a divided into units of 2 MB correspond to the respective bits. The copy management table 214 may indicate, with bits, whether data dopy is completed between areas of the physical volumes of the HDDs 310 and 320 divided into units of 2 MB correspond to the respective bits. Each bit of the copy management table 214 indicates any one of “0” and “1”. When the bit is “0”, it indicates that data dopy is not completed between areas corresponding to the bit. When the bit is “1”, it indicates that data dopy is completed between areas corresponding to the bit. For example, when data copy from an area of the logical volume 310a is completed, the copy unit 222 sets the bit corresponding to the area from which the data is copied as “1”.

Subsequently, each process is described with reference to a flowchart. Since the HDD 320 is a newly introduced HDD as a replacement, even though the HDD 320 is an HDD among the mirroring constituents, the HDD 320 does not yet store therein data which is duplicated with data stored in the HDD 310.

First, a case where a copy process is not performed in the CM 200 is described. A case where the CM 200 receives an access request for the DE 300 from the host device 400 is described with reference to a flowchart.

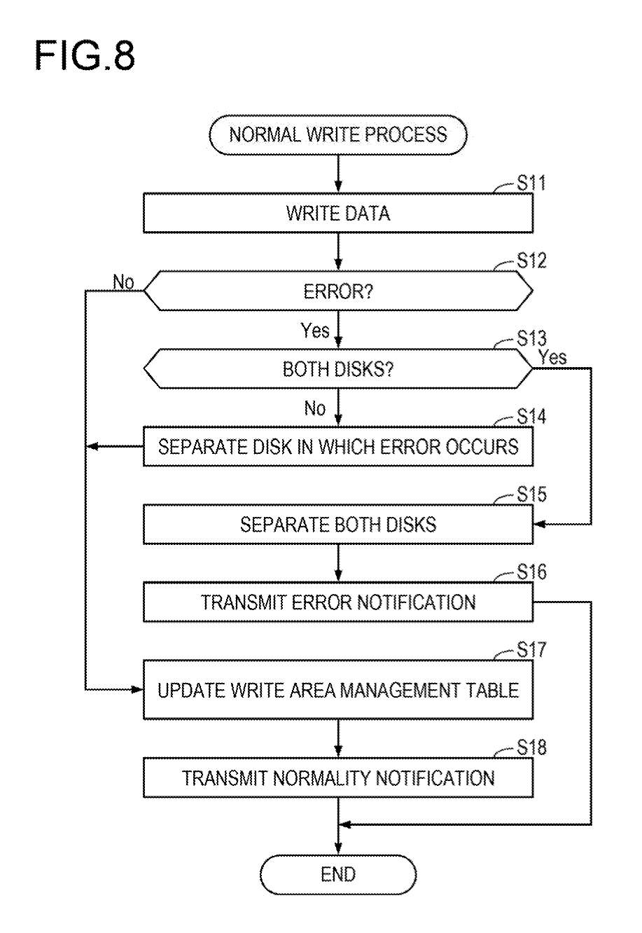

FIG. 8 is a flowchart illustrating an example of a normal write process according to the second embodiment. The copy process is not performed in the control unit 220, and the control unit 220 performs the normal write process upon receiving a write request from the host device 400.

(S11) The mirror unit 221 writes data in areas in the logical volumes 310a and 320a designated by the write request.

(S12) The mirror unit 221 determines whether an error occurs in the data write. When it is determined that an error occurs, the mirror unit 221 proceeds to S13. When no error occurs, the mirror unit 221 proceeds to S17.

(S13) The mirror unit 221 determines whether the error occurs in both the HDDs 310 and 320. When it is determined that the error occurs in both the HDDs 310 and 320, the mirror unit 221 proceeds to S15. When it is determined that the error occurs in any one of HDDs 310 and 320, the mirror unit 221 proceeds to S14.

(S14) The configuration management unit 223 separates the HDD in which the error occurs from the mirroring configuration. The configuration management unit 223 registers “INVALID” in the item of the disk state in the mirror disk management table 211 corresponding to the HDD in which the error occurs. Thereafter the configuration management unit 223 proceeds to S17.

(S15) The configuration management unit 223 separates both the HDDs 310 and 320 from the mirroring configuration. The configuration management unit 223 registers “INVALID” in the item of the disk state in the mirror disk management table 211 corresponding to both the HDDs 310 and 320.

(S16) The mirror unit 221 transmits an error notification to the host device 400. The mirror unit 221 ends the normal write process.

(S17) The mirror unit 221 sets the bit corresponding to the area where the data is written as “1” by referring to the write area management table 212.

(S18) The mirror unit 221 transmits a normality notification to the host device 400. The mirror unit 221 ends the normal write process.

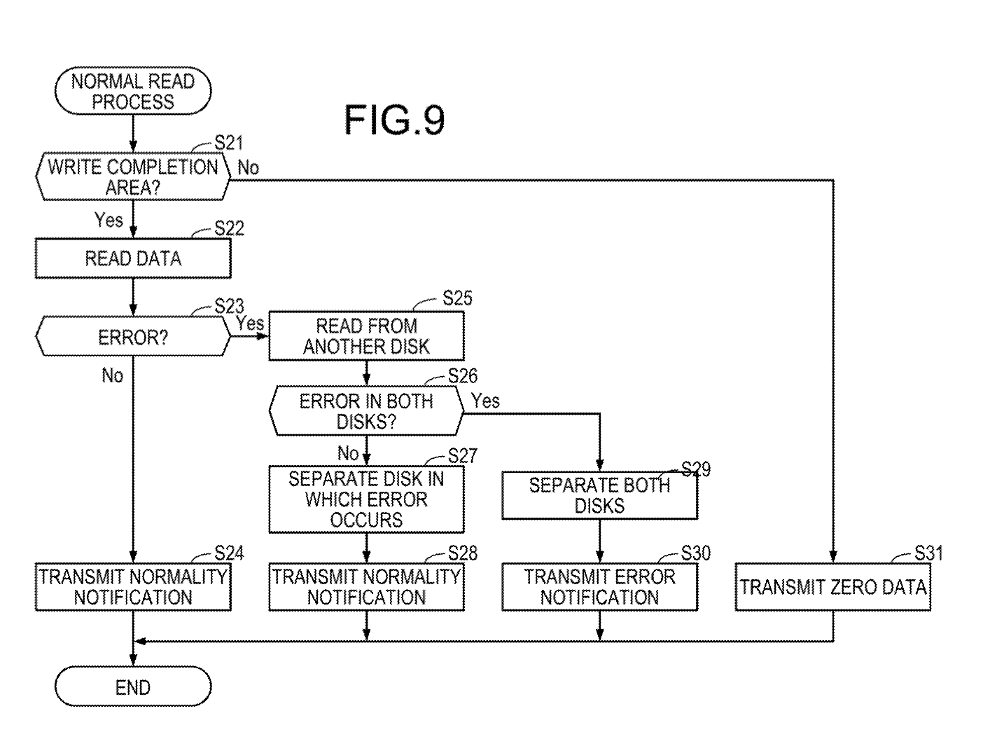

FIG. 9 is a flowchart illustrating an example of a normal read process according to the second embodiment. The copy process is not performed in the control unit 220, and the control unit 220 performs the normal read process upon receiving a read request from the host device 400.

(S21) The mirror unit 221 identifies a bit of the write area management table 212 corresponding to an area designated by the read request. The mirror unit 221 determines whether the area corresponding to the identified bit is a write completion area. When it is determined that the area corresponding to the identified bit is a write completion area (the identified bit is “1”), the mirror unit 221 proceeds to S22. When it is determined that the area corresponding to the identified bit is not a write completion area (the identified bit is “0”), the mirror unit 221 proceeds to S31.

(S22) The mirror unit 221 reads data from the area designated by the read request in the HDD 310 (logical volume 310a) or the HDD 320 (logical volume 320a).

(S23) The mirror unit 221 determines whether an error occurs in the data read. When it is determined that an error occurs, the mirror unit 221 proceeds to S25. When it is determined that no error occurs, the mirror unit 221 proceeds to S24.

(S24) The mirror unit 221 transmits a normality notification to the host device 400. The mirror unit 221 ends the normal read process.

(S25) The mirror unit 221 reads data from the area designated by the read request in the logical volume of an HDD other than the HDD on which the data read is performed in S22. For example, when the HDD on which the data read is performed in S22 is the HDD 310, the mirror unit 221 reads data from the area designated by the read request in the HDD 320.

(S26) The mirror unit 221 determines whether the error occurs in both the HDDs 310 and 320. When it is determined that the error occurs in both the HDDs 310 and 320, the mirror unit 221 proceeds to S29. When it is determined that no error occurs in either the HDD 310 or the HDD 320, the mirror unit 221 proceeds to S27.

(S27) The configuration management unit 223 separates an HDD in which the error occurs from the mirroring configuration. The configuration management unit 223 registers “INVALID” in the item of the disk state in the mirror disk management table 211 corresponding to the HDD in which the error occurs.

(S28) The mirror unit 221 transmits a normality notification to the host device 400. The mirror unit 221 ends the normal read process.

(S29) The configuration management unit 223 separates both the HDDs 310 and 320 from the mirroring configuration. The configuration management unit 223 registers “INVALID” in the item of the disk state in the mirror disk management table 211 corresponding to the HDDs 310 and 320.

(S30) The mirror unit 221 transmits an error notification to the host device 400. The mirror unit 221 ends the normal read process.

(S31) The mirror unit 221 transmits zero data to the host device 400. Herein, the zero data is data indicating that no data exists and for example, data represented by a row of “0”s as bit values. The mirror unit 221 ends the normal read process.

Subsequently, a case where the copy process is performed in the CM 200 is described with reference to a flowchart. Further, a case where the CM 200 receives an access request for the DE 300 from the host device 400 during the copy process is described with reference to a flowchart.

In the following description, it is assumed that the HDD 310 is the copy source disk and the HDD 320 is the copy destination disk. Before the copy unit 222 starts the copy process, the configuration management unit 223 registers “COPY” in the item of the disk state in the mirror disk management table 211 corresponding to the copy destination disk (HDD 320). The item of the disk state in the mirror disk management table 211 corresponding to the copy source disk (HDD 310) is “ACTIVE”.

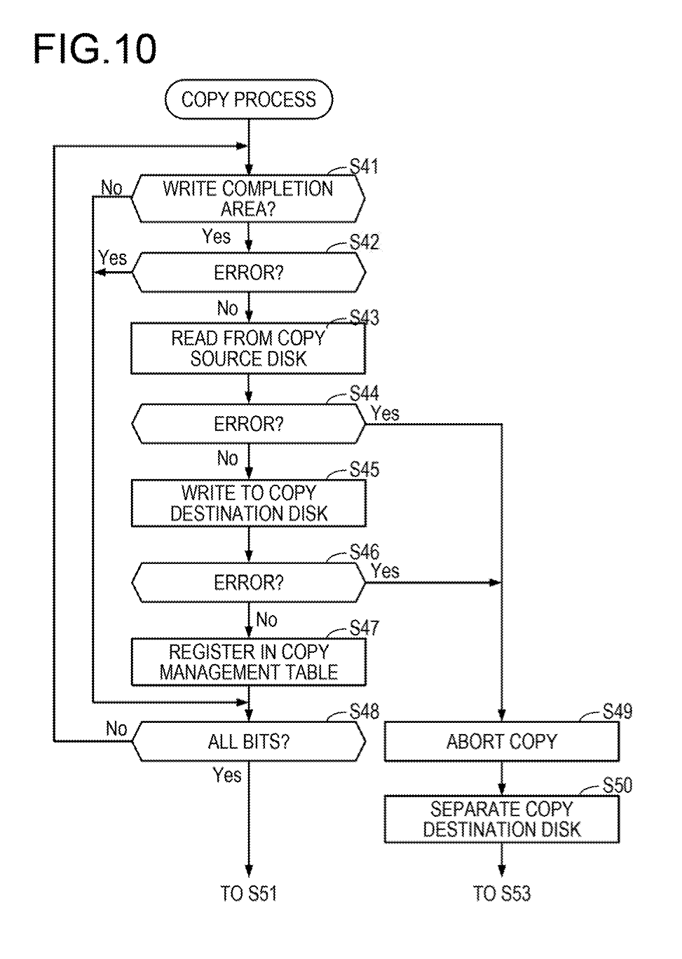

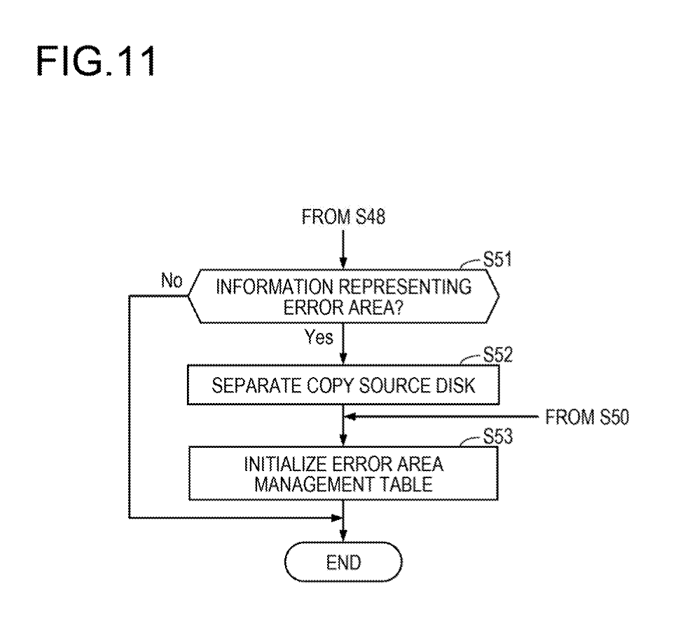

FIG. 10 and FIG. 11 are flowcharts illustrating an example of the copy process according to the second embodiment. The control unit 220 starts to perform the copy process at a predetermined timing. The predetermined timing may be a preset timing or a timing when the copy unit 222 receives an instruction to start the copy process from the host device 400.

(S41) The copy unit 222 selects one bit of the write area management table 212. The copy unit 222 determines whether an area corresponding to the selected bit is a write completion area. When it is determined that the area corresponding to the selected bit is a write completion area (the selected bit is “1”), the copy unit 222 proceeds to S42. When it is determined that the area corresponding to the selected bit is not a write completion area (the selected bit is “0”), the mirror unit 221 proceeds to S48.

(S42) The copy unit 222 identifies the bit of the error area management table 213 corresponding to the bit selected in S41. The copy unit 222 determines whether an area corresponding to the identified bit is an error area. When it is determined that the area corresponding to the identified bit is an error area (the identified bit is “1”), the copy unit 222 proceeds to S48. When it is determined that the area corresponding to the identified bit is not an error area (the identified bit is “0”), the mirror unit 221 proceeds to S43.

(S43) The copy unit 222 reads data from the area of the logical volume 310a of the copy source disk corresponding to the bit selected in S41.

(S44) The copy unit 222 determines whether an error occurs in the data read performed on the copy source disk. When it is determined that an error occurs, the copy unit 222 proceeds to S49. When it is determined that no error occurs, the copy unit 222 proceeds to S45.

(S45) The copy unit 222 writes the data read in S43 in an area of the logical volume 320a of the copy destination disk corresponding to the bit selected in S41.

(S46) The copy unit 222 determines whether an error occurs in the data write performed on the copy destination disk. When it is determined that an error occurs, the copy unit 222 proceeds to S49. When it is determined that no error occurs, the copy unit 222 proceeds to S47.

(S47) The copy unit 222 identifies the bit of the copy management table 214 corresponding to the bit selected in S41. The copy unit 222 sets the identified bit as “1”.

(S48) The copy unit 222 determines whether all bits of the write area management table 212 are selected. When it is determined that all bits are selected, the copy unit 222 proceeds to S51. When it is determined that some of the bits are not selected, the copy unit 222 proceeds to S41.

(S49) The copy unit 222 aborts the data copy.

(S50) The configuration management unit 223 separates the copy destination disk from the mirroring configuration. The configuration management unit 223 registers “INVALID” in the item of the disk state in the mirror disk management table 211 corresponding to the copy destination disk. The configuration management unit 223 proceeds to S53.

(S51) The copy unit 222 determines whether information representing an error area is registered (the bit is “1”) by referring to the error area management table 213. When it is determined that the information representing an error area is registered, the copy unit 222 proceeds to S52. When it is determined that the information representing an error area is not registered, the configuration management unit 223 registers “ACTIVE” in the item of the disk state in the mirror disk management table 211 corresponding to the copy source disk and the copy destination disk. The copy unit 222 ends the copy process.

(S52) The configuration management unit 223 separates the copy source disk from the mirroring configuration. The configuration management unit 223 registers “INVALID” in the item of the disk state in the mirror disk management table 211 corresponding to the copy source disk. The configuration management unit 223 registers “ACTIVE” in the item of the disk state in the mirror disk management table 211 corresponding to the copy destination disk.

The mirror unit 221 refers to the mirror disk management table 211 to count the number of mirror disks. The mirror unit 221 aborts the control of the mirroring when the number of mirror disks is one (when the number of HDDs having “ACTIVE” in the item of the disk state in the mirror disk management table 211 is one).

(S53) The copy unit 222 deletes the information registered in the error area management table 213. That is, the copy unit 222 initializes the error area management table 213. The copy unit 222 ends the copy process.

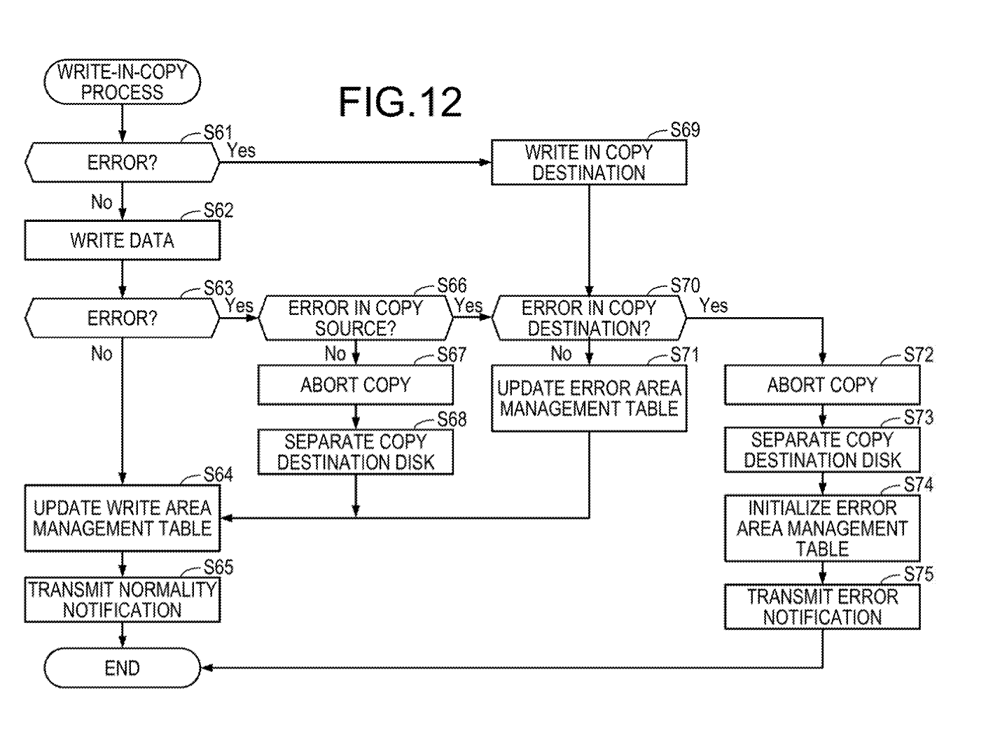

FIG. 12 is a flowchart illustrating an example of a write-in-copy process according to the second embodiment. The control unit 220 performs the write-in-copy process upon receiving a write request from the host device 400 during the copy process.

(S61) The mirror unit 221 identifies the bit of the error area management table 213 corresponding to an area designated by the write request. The mirror unit 221 determines whether an area corresponding to the identified bit is an error area. When it is determined that the area corresponding to the identified bit is an error area (the identified bit is “1”), the mirror unit 221 proceeds to S69. When it is determined that the area corresponding to the identified bit is not an error area (the identified bit is “0”), the mirror unit 221 proceeds to S62.

(S62) The mirror unit 221 writes data in the area designated by the write request among the areas of the logical volume 310a of the copy source disk. The mirror unit 221 writes the data in the area designated by the write request among the areas of the logical volume 320a of the copy destination disk.

(S63) The mirror unit 221 determines whether an error occurs in the data write. When it is determined that an error occurs, the mirror unit 221 proceeds to S66. When it is determined that no error occurs, the mirror unit 221 proceeds to S64.

(S64) The mirror unit 221 sets the bit corresponding to the area where the data is written as “1”, in the write area management table 212.

(S65) The mirror unit 221 transmits a normality notification to the host device 400. The mirror unit 221 ends the write-in-copy process.

(S66) The mirror unit 221 determines whether the error occurs in the copy source disk. When it is determined that the error occurs in the copy source disk, the mirror unit 221 proceeds to S70. When it is determined that the error occurs in the copy destination disk, the mirror unit 221 proceeds to S67.

(S67) The copy unit 222 aborts the data copy.

(S68) The configuration management unit 223 separates the copy destination disk from the mirroring configuration. The configuration management unit 223 registers “INVALID” in the item of the disk state in the mirror disk management table 211 corresponding to the copy destination disk. The configuration management unit 223 proceeds to S64.

(S69) The mirror unit 221 writes the data in the area designated by the write request among the areas of the logical volume 320a of the copy destination disk.

(S70) The mirror unit 221 determines whether an error occurs in the copy destination disk. When it is determined that the error occurs in the copy destination disk, the mirror unit 221 proceeds to S72. When it is determined that no error occurs in the copy destination disk, the mirror unit 221 proceeds to S71.

(S71) The mirror unit 221 sets the bit of the error area management table 213 corresponding to the error area as “1”. The mirror unit 221 proceeds to S64.

(S72) The copy unit 222 aborts the data copy.

(S73) The configuration management unit 223 separates the copy destination disk from the mirroring configuration. The configuration management unit 223 registers “INVALID” in the item of the disk state in the mirror disk management table 211 corresponding to the copy destination disk.

(S74) The mirror unit 221 deletes the information registered in the error area management table 213. That is, the mirror unit 221 initializes the error area management table 213.

(S75) The mirror unit 221 transmits an error notification to the host device 400. The mirror unit 221 ends the write-in-copy process.

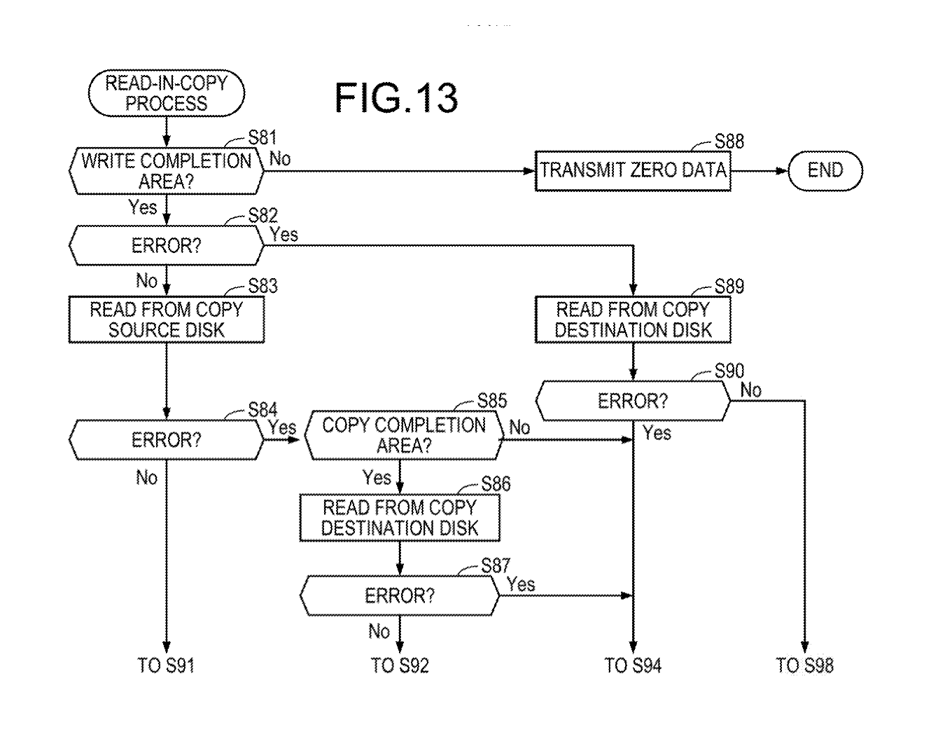

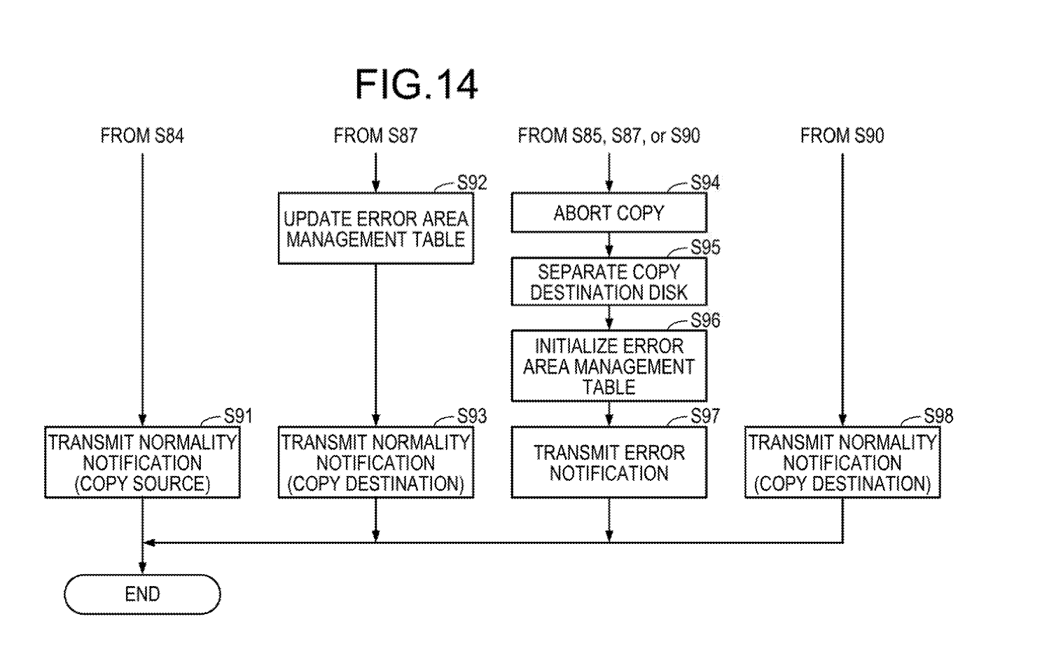

FIG. 13 and FIG. 14 are flowcharts illustrating an example of the read-in-copy process according to the second embodiment. The control unit 220 performs the read-in-copy process upon receiving a read request from the host device 400 during the copy process.

(S81) The mirror unit 221 identifies the bit of the write area management table 212 corresponding to an area designated by the read request. The mirror unit 221 determines whether an area corresponding to the identified bit is an write completion area. When it is determined that the area corresponding to the identified bit is a write completion area (the identified bit is “1”), the mirror unit 221 proceeds to S82. When it is determined that the area corresponding to the identified bit is not a write completion area (the identified bit is “0”), the mirror unit 221 proceeds to S88.

(S82) The mirror unit 221 identifies the bit of the error area management table 213 corresponding to the area designated by the read request. The mirror unit 221 determines whether an area corresponding to the identified bit is an error area. When it is determined that the area corresponding to the identified bit is an error area (the identified bit is “1”), the mirror unit 221 proceeds to S89. When it is determined that the area corresponding to the identified bit is not an error area (the identified bit is “0”), the mirror unit 221 proceeds to S83.

(S83) The mirror unit 221 reads data from the area designated by the read request among the areas of the logical volume 310a of the copy source disk.

(S84) The mirror unit 221 determines whether an error occurs in the data read performed on the copy source disk. When it is determined that an error occurs, the mirror unit 221 proceeds to S85. When it is determined that no error occurs, the mirror unit 221 proceeds to S91.

(S85) The mirror unit 221 identifies the bit of the copy management table 214 corresponding to the area designated by the read request. The mirror unit 221 determines whether an area corresponding to the identified bit is the area (hereinafter, referred to as a “copy completion area”) where the copy is completed. When it is determined that the area corresponding to the identified bit is a copy completion area (the identified bit is “1”), the mirror unit 221 proceeds to S86. When it is determined that the area corresponding to the identified bit is not a copy completion area (the identified bit is “0”), the mirror unit 221 proceeds to S94.

(S86) The mirror unit 221 reads data in the area designated by the read request among the areas of the logical volume 320a of the copy destination disk.

(S87) The mirror unit 221 determines whether an error occurs in the data read performed on the copy destination disk. When an error occurs, the mirror unit 221 proceeds to S94. When no error occurs, the mirror unit 221 proceeds to S92.

(S88) The mirror unit 221 transmits zero data to the host device 400. The mirror unit 221 ends the read-in-copy process.

(S89) The mirror unit 221 reads data in the area designated by the read request among the areas of the logical volume 320a of the copy destination disk.

(S90) The mirror unit 221 determines whether an error occurs in the data read performed on the copy destination disk. When it is determined that an error occurs, the mirror unit 221 proceeds to S94. When it is determined that no error occurs, the mirror unit 221 proceeds to S98.

(S91) The mirror unit 221 transmits a notification indicating that the data is normally read from the copy source disk to the host device 400. The mirror unit 221 ends the read-in-copy process.

(S92) The mirror unit 221 sets the bit of the error area management table 213 corresponding to the error area as “1”.

(S93) The mirror unit 221 transmits a notification indicating that the data is normally read from the copy destination disk to the host device 400. The mirror unit 221 ends the read-in-copy process.

(S94) The copy unit 222 aborts the data copy.

(S95) The configuration management unit 223 separates the copy destination disk from the mirroring configuration. The configuration management unit 223 registers “INVALID” in the item of the disk state in the mirror disk management table 211 corresponding to the copy destination disk.

(S96) The mirror unit 221 deletes the information registered in the error area management table 213. That is, the mirror unit 221 initializes the error area management table 213.

(S97) The mirror unit 221 transmits an error notification to the host device 400. The mirror unit 221 ends the read-in-copy process.

(S98) The mirror unit 221 transmits a notification indicating that the data is normally read from the copy destination disk to the host device 400. The mirror unit 221 ends the read-in-copy process.

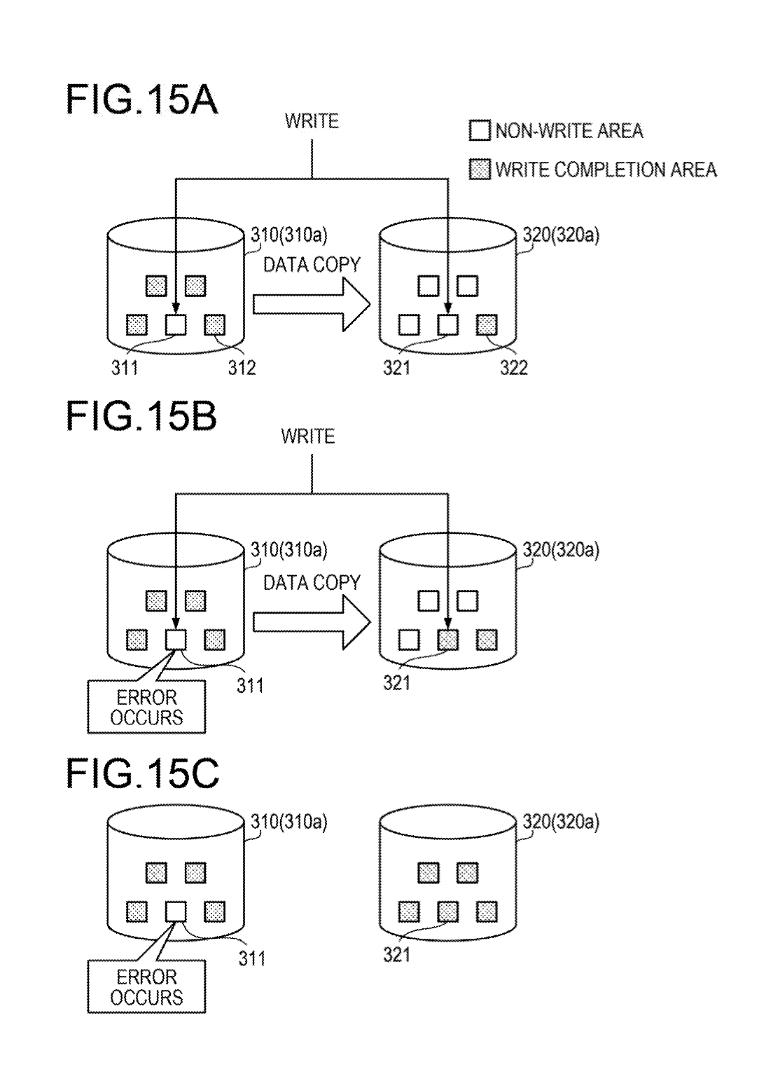

FIGS. 15A to 15C are diagrams illustrating an example of the write-in-copy process according to the second embodiment. The HDD 320 is a newly introduced HDD as a replacement. FIG. 15A illustrates a case where the copy process is performed after the normal write process is performed. Areas 312 and 322 are areas where data is written through the normal write process by the mirror unit 221. FIG. 15A illustrates that areas (hereinafter, referred to as non-write areas) in which data is not yet written and write completion areas coexist in the areas of the logical volumes 310a and 320a. For example, FIG. 15A illustrates that the areas 311 and 321 are non-write areas. For example, FIG. 15A illustrates that the areas 312 and 322 are write completion areas.

The HDD 310 is the copy source disk. The HDD 320 is the copy destination disk. The copy unit 222 performs the copy process. The copy unit 222 copies data stored in write completion areas among the areas of the logical volume 310a to the logical volume 320a by referring to the write area management table 212.

The mirror unit 221 receives a write request from the host device 400 during the copy process. The mirror unit 221 writes data in the areas 311 and 321.

FIG. 15B illustrates that an error occurs when the mirror unit 221 writes the data in the area 311. FIG. 15B illustrates that no error occurs when the mirror unit 221 writes the data in the area 321. The copy unit 222 excludes data stored in the area 311 from the copy-target data (Yes in S42).

FIG. 15C illustrates that the copy process is completed. The configuration management unit 223 separates the HDD 310 from the mirroring configuration (S52). The configuration management unit 223 registers “INVALID” in the item of the disk state in the mirror disk management table 211 corresponding to the HDD 310. The configuration management unit 223 registers “ACTIVE” in the item of the disk state in the mirror disk management table 211 corresponding to the HDD 320. The HDD 310 is an operation disk. The HDD 320 is an operation disk.

According to the second embodiment, the CM 200 excludes data corresponding to an error area from the copy-target data in the data copy to prevent indefinite data from being copied from the copy source disk to the copy destination disk.

As a result, the CM 200 prevents the copy destination disk from being a state in which data is not guaranteed. Since the CM 200 normally writes the write data of the write request instead of the data excluded from the copy-target data, the copy destination disk may be used as a storage device in which data is guaranteed.

Therefore, the CM 200 may guarantee data in the copy destination disk even when an error occurs in the copy source disk during the copy process.

According to the second embodiment, since the CM 200 excludes non-write areas from the copy-target data during the copy process, the CM 200 may shorten time spent on the copy process.

According to the second embodiment, when the CM 200 receives a write request to write data in an error area in the logical volume 310a during the copy process, the CM 200 writes the data in an area of the logical volume 320a corresponding to the error area in the logical volume 310a. As described above, the CM 200 may write data in the copy destination disk (HDD 320) while continuously performing the copy process even when an error occurs in the copy source disk (HDD 310). Further, the CM 200 may store latest data in the copy destination disk.

According to the second embodiment, when the CM 200 receives a read request to read data from an error area in the logical volume 310a during the copy process, the CM 200 reads data from an area of the logical volume 320a corresponding to the error area in the logical volume 310a. As described above, the CM 200 may read data from the copy destination disk (HDD 320) even when an error occurs in the copy source disk (HDD 310).

The information processing in the first embodiment may be implemented by causing a processor in the information processing device 2 to execute a program. The information processing in the second embodiment may be implemented by causing the CPU 201 to execute a program. The program may be written in a computer-readable recording medium.

For example, the program may be distributed by circulating the computer-readable recording medium having stored therein the program. A program that implements a function equivalent to the control unit 220 may be set as a separate program to separately distribute each program. The function of the control unit 220 may be implemented by a separate computer. The computer may, for example, store the program stored in the recording medium in the RAM 202 or the flash memory 203, and read and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
performing data copy of copying data from a first storage device to a second storage device;
receiving a first write request while performing the data copy, the first write request requesting to write first data in a first area of the first storage device;
performing first data write of writing the first data in the first area;
performing second data write of writing the first data in a second area of the second storage device, the second area corresponding to the first area;
storing abnormality information in a memory upon detecting normal completion of the second data write and an error occurred in the first data write, the abnormality information indicating the first area; and
continuously performing the data copy while excluding data stored in the first area from copy-target data on basis of the abnormality information stored in the memory, the copy-target data being data to be copied by the data copy.

2. The non-transitory computer-readable recording medium according to claim 1, wherein
the first storage device and the second storage device are mirroring constituents,
the process comprising:
excluding the first storage device from the mirroring constituents after completing the data copy.

3. The non-transitory computer-readable recording medium according to claim 1, the process comprising:
performing the data copy upon detecting that the second storage device is added to mirroring constituents due to a change in a configuration of the mirroring constituents.

4. The non-transitory computer-readable recording medium according to claim 1, the process further comprising:
storing write information in the memory, the write information indicating write completion areas of the first storage device, in which data is written; and
copying data stored in the write completion areas, as the copy-target data, in the data copy on basis of the write information.

5. The non-transitory computer-readable recording medium according to claim 1, the process further comprising:
receiving a second write request while performing the data copy, the second write request requesting to write second data in a third area of the first storage device;
determining whether first abnormality information indicating the third area is stored in the memory; and
performing, upon determining that the first abnormality information is stored in the memory, data write of writing the second data in a fourth area of the second storage device without performing data write of writing the second data in the third area, the fourth area corresponding to the third area.

6. The non-transitory computer-readable recording medium according to claim 1, the process further comprising:
receiving a read request while performing the data copy, the read request requesting to read second data from a third area of the first storage device;
determining whether first abnormality information indicating the third area is stored in the memory; and
performing, upon determining that the first abnormality information is stored in the memory, data read of reading the second data from a fourth area of the second storage device, the fourth area corresponding to the third area.

7. An information processing device, comprising:
a memory; and
a processor coupled to the memory and the processor configured to:
perform data copy of copying data from a first storage device to a second storage device;
receive a first write request while performing the data copy, the first write request requesting to write first data in a first area of the first storage device;
perform first data write of writing the first data in the first area;
perform second data write of writing the first data in a second area of the second storage device, the second area corresponding to the first area;
store abnormality information in the memory upon detecting normal completion of the second data write and an error occurred in the first data write, the abnormality information indicating the first area; and
continuously perform the data copy while excluding data stored in the first area from copy-target data on basis of the abnormality information stored in the memory, the copy-target data being data to be copied by the data copy.

8. An information processing system, comprising:
a first storage device;
a second storage device different from the first storage device; and
an information processing device including:
a memory; and
a processor coupled to the memory and the processor configured to:
perform data copy of copying data from the first storage device to the second storage device;
receive a first write request while performing the data copy, the first write request requesting to write first data in a first area of the first storage device;
perform first data write of writing the first data in the first area;
perform second data write of writing the first data in a second area of the second storage device, the second area corresponding to the first area;
store abnormality information in the memory upon detecting normal completion of the second data write and an error occurred in the first data write, the abnormality information indicating the first area; and
continuously perform the data copy while excluding data stored in the first area from copy-target data on basis of the abnormality information stored in the memory, the copy-target data being data to be copied by the data copy.
